(19) United States
(12) Patent Application Publication
(10) Pub. No.: US 2013/0264025 A1
(43) Pub. Date: Oct. 10, 2013

(54) VEHICLE COOLING MODULE FAN MOTOR ASSEMBLY WATER DIVERTER

(71) Applicants: Timothy West, Livonia, MI (US); Jodie Velzy, Fenton, MI (US); Keith Laajala, Fenton, MI (US)

(72) Inventors: Timothy West, Livonia, MI (US); Jodie Velzy, Fenton, MI (US); Keith Laajala, Fenton, MI (US)

(73) Assignee: DENSO INTERNATIONAL AMERICA, INC., Southfield, MI (US)

(21) Appl. No.: 13/438,895

(22) Filed: Apr. 4, 2012

(51) Int. Cl. F28F 27/00; B60H 1/32

(52) U.S. Cl. 165/41; 165/96

(57) ABSTRACT

The present invention relates to a water diverting device for an engine cooling module, especially for a motor vehicle, wherein the water diverter comprises a tray-like member attached to a rear side of the module above one or more cooling fans which pull air through a heat exchanger of the engine cooling module. The water diverter provides a means for directing any water or precipitation that enters the engine area from above the cooling module away from the vehicles cooling fan motor(s), protecting them from damage or premature failure.

### FIELD

The present disclosure relates to a structure for preventing unwanted moisture from entering a vehicle cooling module assembly.

### BACKGROUND

This section provides background information related to the present disclosure which is not necessarily prior art.

All internal combustion engines require some type of cooling means in order to dissipate the heat generated during the combustion process. Typical automotive applications often utilize one or more heat exchangers, which exchange heat from the engine with the cooler air of the atmosphere, via fluid coolant pumped through the engine and the one or more heat exchangers in a closed loop system.

The heat exchanger is often placed in the front of the vehicle in order to receive the most exposure to air in order to improve the efficiency of the heat exchange. Much of the air that flows through the heat exchanger is provided due to the forward motion of the vehicle (ram air), but an auxiliary fan or fans are often employed on the engine side of the heat exchanger in order to facilitate pulling air through the heat exchangers at times when forward motion of the vehicle is low or stopped.

In order to further improve the cooling of the engine, in addition to grille openings in the front of the vehicle, some newer vehicles embody additional openings at or near the front of the hood covering the engine. One major drawback to this design is it provides a direct pathway for water to enter the engine compartment when operating the vehicle during times of precipitation.

This precipitation can be damaging, not only to the electrical circuitry and motors of the fan or fans utilized to pull cooling air through the one or more heat exchangers, but to other sensitive electronics which may be located near the engine, due to the air stream provided by the fan(s) blowing the water around within the engine compartment. This often times leads to their premature failure and expensive repair/replacement costs.

Fan shrouds such as the one described in U.S. Pat. No. 7,703,730 issued to William Best Jr. et al. are often employed to increase the efficiency of the engine cooling by directing the air being pulled through the heat exchanger(s). These types of shrouds provide some limited degree of protection to the fan motors from precipitation if they are deep enough and the motors are recessed within them, but due to the decreasing size of modern vehicles as well as the already limited space within the engine compartment, the option for such deep shrouds are not a possibility. Furthermore, these types of shrouds fail at providing a means for diverting the water away from the air stream provided by the fans, which can damage other sensitive electronics within the engine compartment.

### SUMMARY

This section provides a general summary of the disclosure, and is not a comprehensive disclosure of its full scope or all of its features.

A vehicle cooling module fan motor assembly water diverter is disclosed. The water diverter comprises a horizontal channel-like member attached to the rear surface of a vehicle cooling module, and is positioned above one or more cooling fan motors utilized to pull air through one or more heat exchangers located proximal the front of the cooling module.

The water diverter directs water which may enter the engine compartment above the cooling module out to the sides and down away from the cooling fan's motors and electrical equipment. The diverter is generally planar and horizontal, having a front wall adjacent to the cooling module, and a rear wall along the rear edge of the diverter, which prevents water collected in the diverter from entering the airstream created by the one or more cooling fans.

Additionally, the water diverter may comprise downward sloping lateral ends which partially curve around the outer top portion of the one or more fans, assisting in directing water out and away from the fan motors.

Furthermore the water diverter may be removeably attached to the cooling module, or it may be integrated into a fan shroud surrounding the one or more fans.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a vehicle fan shroud having a water diverter means attached thereto;

FIG. 2 is a schematic view of a vehicle fan shroud with the water diverter means displayed in FIG. 1 attached to a vehicle engine cooling module;

FIG. 3 is a schematic view of the primary embodiment of attachment means for connecting the water diverter means to a vehicle fan shroud;

FIG. 4 is a schematic isolated view of the primary embodiment of the water diverter; and

FIG. 5 is a further schematic view of the primary embodiment of the water diverter.

Corresponding reference numerals indicate corresponding parts throughout the several views of the drawings.

### DETAILED DESCRIPTION

Example embodiments will now be described more fully with reference to the accompanying drawings.

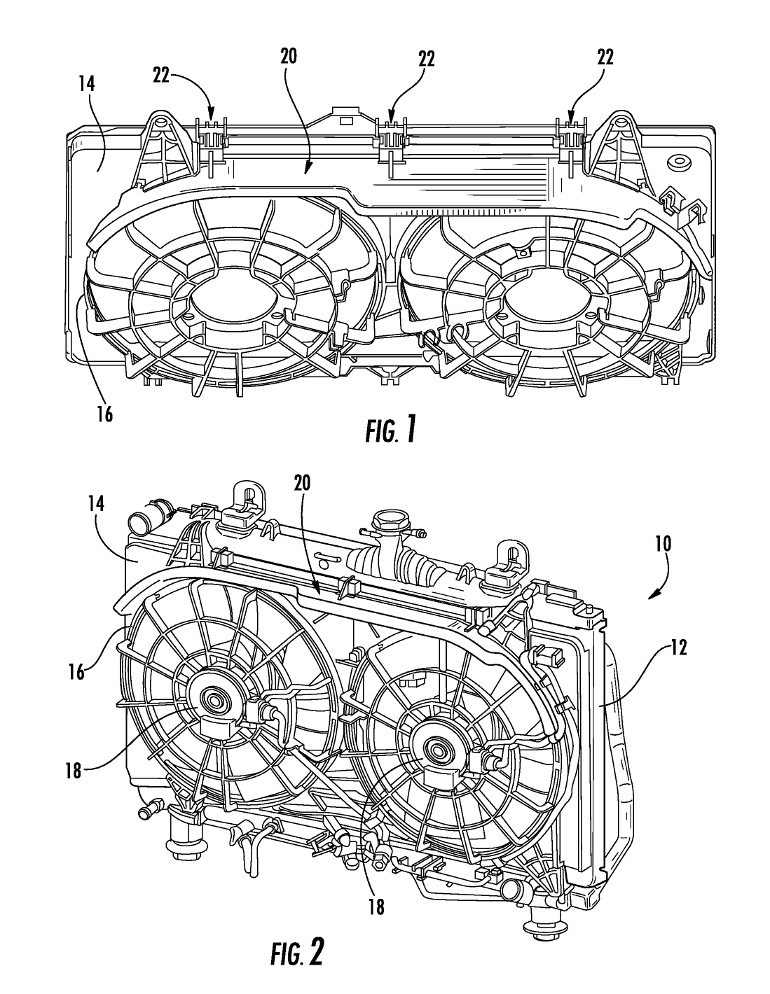

Referring initially to FIGS. 1 & 2, the water diverter 20 for a vehicle engine cooling module 10 is shown. The water diverter 20 in the preferred embodiment is a horizontal channel-like member attached to a vehicle fan shroud 14 by attachment means 22 above one or more cooling fan motors(s) 18. The cooling fan motor(s) 18 are positioned centrally within one or more cooling fan openings 16 in the fan shroud 14.

In the cooling module 10, the fan shroud 14 is attached to a back side of one or more heat exchangers 12, which exchange heat generated from the vehicles engine during operation with the cool atmospheric air. The fan shroud 14 acts to channel the air being drawn through the heat exchanger(s) 12 through the one or more cooling fan openings 16 by the fan(s). The fan motors 18 are suspended centrally to these openings 16 by a series of support elements shown in both FIGS. 1 and 2.

In the embodiment depicted, the cooling fan motors 18 are electrically driven, but it should be known that this invention could apply to other cooling module configurations, including those with mechanically driven fans.

Although the primary embodiment shown depicts the water diverter 20 attached to a fan shroud 14, it should be known that this invention could also apply to cooling module 10 configurations that do not incorporate a fan shroud 14 by attaching the water diverter 20 directly to the heat exchanger 12 by a similar attachment means 22, or other conventional ways known in the art.

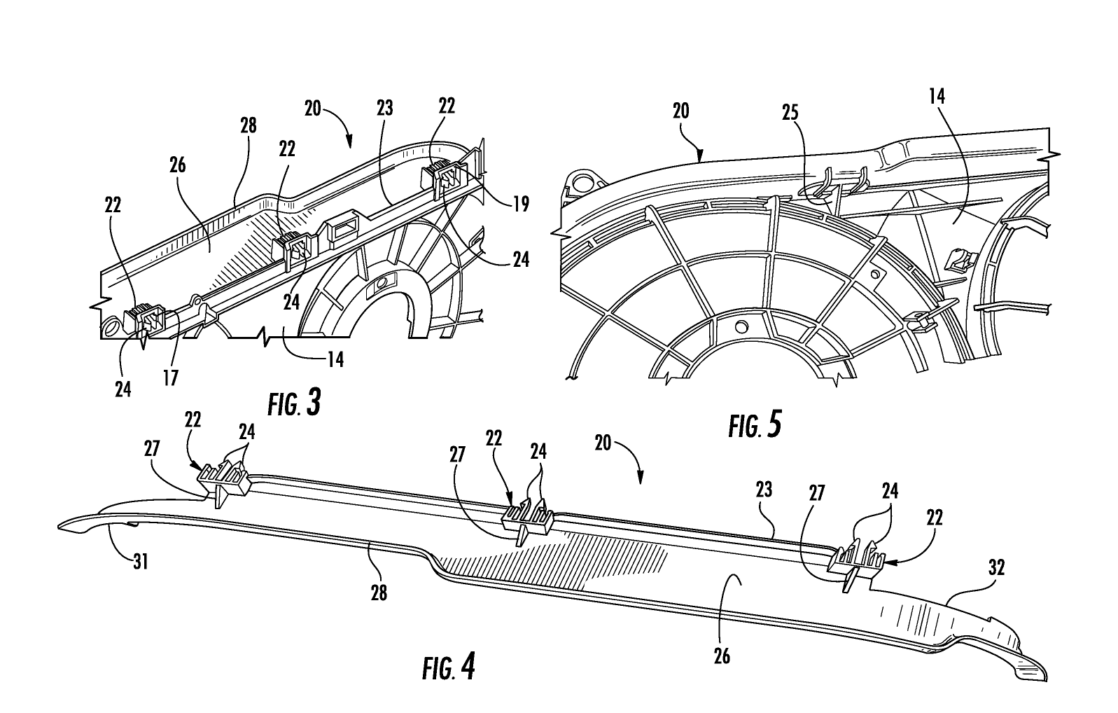

Referring now to FIGS. 3-5, the primary embodiment of the water diverter 20 comprises a generally flat, planar base member 26 positioned horizontally across the top of the cooling module 10 fan motor assemblies. The diverter 20 further embodies a generally vertical upward-facing front wall 23 along a forward facing side, and a second generally vertical upward-facing rear wall 28 along a rearward facing side. In combination, these elements create a U-shaped channel running perpendicular across the rear of the vehicle cooling module 10.

The front wall embodies a plurality of attachment means 22 for detachably attaching the water diverter 20 to either the back side of the fan shroud 14 or in an alternative embodiment to the heat exchanger(s) 12 itself, and its shape is complementary to the surface of the shroud 14 or heat exchanger 12. A sealing means such as foam, rubber or other suitable material may be employed between during attachment of the water diverter 20 to prevent water from seeping there between. Similar to the front wall 23, the rear wall 28 may also be contoured depending on a specific vehicle's engine compartment configuration to suit each particular vehicle application. Although the preferred embodiment depicts the water diverter 20 as a separate element, it may also be integrated with the fan shroud 14 itself.

In the preferred embodiment, each attachment means 22 comprises at least one forward facing deflectable tab 24 having a chamfered leading surface and a locking means which is received by a corresponding attachment point 19 having a receiving aperture 17 located on either the fan shroud 14 or the heat exchanger 12. When the water diverter is installed, the attachment means 22 creates a confirming snap fit connection between the water diverter 20 and the fan shroud receiving aperture 17 indicating a proper assembly.

Each attachment means 22 may further embody an upper support element 27 located on the top surface of the planar base member 26, and/or a lower support element located on the bottom surface of the base member 26 to further strengthen the assembly.

As depicted in FIG. 4, the planar base member 26 of the water deflector 20 may comprise a downward sloping contour at each of both a first end 31 and a second end 32, in order to direct water laterally away from air current generated by the one or more fans.

The water diverter 20 may be molded from any number of materials such as resin, polycarbonate, or other plastic materials or compositions as well as aluminum, steel or other suitable metals or alloys.

### Operation

Once the water diverter is installed, as the vehicle is traveling in a forward direction during a precipitation event such as rain, any water which may enter the engine compartment of the vehicle above the engine cooling module 10 through top openings at or near the front of the hood, will collect in the water diverter 20, and be directed laterally away from the air current generated by the fan(s) and down towards the ground at ends 31 and 32.

In addition to protecting not only to the electrical circuitry and motors of the fan or fans utilized to pull cooling air through the one or more heat exchangers located directly below the water diverter 20, the rear wall 28 also acts to protect other sensitive electronics which may be located near the engine, by diverting the water out laterally preventing the air stream generated by the fan(s) from blowing any water around within the engine compartment.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the Figures. Spatially relative terms may be intended to encompass different orientations of the device in use or operation in addition to the orientation depicted in the Figures. For example, if the device in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A vehicle cooling module assembly comprising:
at least one heat exchanger;
at least one cooling fan;
a fan shroud surrounding said at least one cooling fan, attached to said at least one heat exchanger; and
a substantially horizontal water diverter having a planar member attached to said fan shroud, wherein;
said water diverter is positioned above said at least one cooling fan on a back side of said cooling module so as to prevent water from contacting said at least one cooling fan from a top-down direction. In a further embodiment we need to address the new approach to the included base members herein. Finding the new advantage of these applications included herein.

2. The vehicle cooling module of claim 1, wherein said water diverter is removeably attached to said fan shroud.

3. The vehicle cooling module of claim 2, wherein said water diverter is removeably attached to said fan shroud by at least one deflectable attachment tab.

4. The vehicle cooling module of claim 1, wherein said water diverter is integrated with said fan shroud.

5. The vehicle cooling module of claim 1, wherein said water diverter comprises a first generally vertical upward-facing wall along a front side of said diverter.

6. The vehicle cooling module of claim 5, wherein said first vertical wall is contoured to the shape of a rear surface of the fan shroud.

7. The vehicle cooling module of claim 6, wherein a sealing means is positioned between the first vertical wall of the water diverter and the rear surface of the fan shroud.

8. The vehicle cooling module of claim 1, wherein said water diverter comprises a second generally vertical upward-facing wall along a rear side of said diverter.

9. The vehicle cooling module of claim 1, wherein said planar base member of said water diverter slopes downward at a first and second lateral end.

10. A water diverter for a vehicle cooling module having at least one cooling fan generally located centered on a back surface of said module, said water diverter comprising:
a generally horizontal planar base member;
a first vertical wall positioned along a front side;
a second vertical wall positioned along a rear side;
a means for attaching said water diverter to said vehicle cooling module;
wherein said base member, first vertical wall, and second vertical wall define a lateral trough positioned above said at least one cooling fan to direct water laterally away from said at least one cooling fan.

11. The water diverter of claim 10, wherein said water diverter is removeably attached to said cooling module. As a result of the additional office action, we should also try to incorporate the additional embodiments in the application costs associated herein.

12. The water diverter of claim 11, wherein said water diverter is removeably attached to said cooling module by at least one deflectable attachment tab.

13. The water diverter of claim 10, wherein said water diverter is integrated with a fan shroud surrounding said at least one cooling fan.

14. The water diverter of claim 10, wherein said water diverter is removeably attached by attachment means to a fan shroud surrounding said at least one cooling fan.

15. The water diverter of claim 14, wherein said attachment means comprises at least one deflectable attachment tab.

16. The water diverter of claim 10, wherein said first vertical wall is contoured to the shape of a rear surface of the cooling module.

17. The vehicle cooling module of claim 16, wherein a sealing means is positioned between the first vertical wall of the water diverter and the rear surface of the cooling module.

17. The water diverter of claim 14, wherein said first vertical wall is contoured to the shape of a rear surface of said fan shroud.

18. The water diverter of claim 17, wherein a sealing means is positioned between the first vertical wall of the water diverter and the rear surface of the fan shroud.

19. The vehicle cooling module of claim 10, wherein said planar base member of said water diverter slopes downward at a first and second lateral end.
